(19) United States
(12) Patent Application Publication
(10) Pub. No.: US 2017/0134466 A1
(43) Pub. Date: May 11, 2017

(54) SERVER-SIDE SESSION CONTROL IN MEDIA STREAMING BY MEDIA PLAYER DEVICES

(71) Applicant: VID SCALE, INC., Wilmington (DE)

(72) Inventor: Alexander Giladi, Princeton, NJ (US)

(21) Appl. No.: 15/321,118

(22) PCT Filed: Jul. 1, 2015
(86) PCT No.: PCT/US2015/038870

§ 371 Date: Dec. 21, 2016

Related U.S. Application Data
(60) Provisional application No. 62/019,885, filed on Jul. 1, 2014.
(60) Provisional application No. 62/159,903, filed on May 11, 2015.

(51) Int. Cl. H04L 29/06; H04N 21/81; H04N 21/262; H04N 21/234; H04L 29/08; H04N 21/2387

(52) U.S. Cl. CPC H04L 65/602; H04L 65/1089; H04L 65/4084; H04L 67/02; H04N 21/2387; H04N 21/26258; H04N 21/23424; H04N 21/8126

(57) ABSTRACT

Systems and methods to interrupt a DASH client-initiated playback and switch to different content. Content associated with emergency alerts, media blackouts, targeted ad insertion may be switched by a DASH server, where the server causes a DASH client to interrupt and resume playback in a manner similar to forced channel switching.

### CLAIM OF PRIORITY AND RELATED APPLICATIONS

This application claims priority of U.S. Provisional Application No. 62/019,885 filed on Jul. 1, 2014, the contents of which are incorporated by reference herein. This application also claims priority of U.S. Provisional Application Ser. No. 62/159,903 filed on May 11, 2015, the contents of which are incorporated by reference herein.

### INCORPORATED BY REFERENCE

The following documents are incorporated herein by reference.
[1] ISO/IEC 23009-1:2014 2^{nd} ed., Information Technology—Dynamic adaptive streaming over HTTP (DASH)—Part 1: Media presentation description and segment formats
[2] ISO/IEC DTR 23009-3:201X 2^{nd} ed. Information Technology—Dynamic adaptive streaming over HTTP (DASH)—Part 3: Implementation Guidelines
[3] ISO/IEC 23009-4:2013 Information Technology—Dynamic adaptive streaming over HTTP (DASH)—Part 4: Segment Encryption and Authentication
[5] http://dashif.org/wp-content/uploads/2015/04/DASH-IF-IOP-v3.0.pdf
[6] ITU-T Rec. H.222.0—ISO/IEC 13818-1:2014, Information technology—Generic coding of moving pictures and associated audio information: Systems
[7] ISO/IEC 14496-12, Information technology—Coding of audio-visual objects—Part 12: ISO base media file format (technically identical to ISO/IEC 15444-12)
[8] ISO/IEC 23001-7:2015 3^{rd} ed., Information technology—MPEG systems technologies—Part 7: Common encryption in ISO base media file format files
[9] A. Giladi, MPEG DASH: A Brief Introduction, IEEE COMSOC MMTC E-Letter, vol. 8, no. 2, March 2013.
[11] ANSI/SCTE 128-1 2013, AVC Video Constraints for Cable Television, Part 1-Coding
[12] XML Signature Syntax and Processing (Second Edition), W3C Recommendation 10 Jun. 2008, www.w3.org/TR/xmldsig-core/
[13] Event Scheduling and Notification Interface, OC-SP-ESNI-I02-131001, www.cablelabs.com/wp-content/uploads/specdocs/OC-SP-ESNI-I02-131001.pdf

### BACKGROUND

Several market trends and technology developments have resulted in the emergence of “over-the-top” (OTT) streaming, which utilizes the Internet as a delivery medium. Hardware capabilities have evolved enough to create a wide range of video-capable devices, ranging from mobile devices to Internet set-top boxes (STBs) to network TVs, while network capabilities have evolved enough to make high-quality video delivery over the Internet viable.

As opposed to the traditional “closed” networks, which are completely controlled by the multi-system operator (MSO), Internet is a “best effort” environment, where bandwidth and latency are constantly changing. In particular, network conditions are highly volatile in mobile networks. Such volatility makes dynamic adaptation to network changes a necessity in order to provide a tolerable user experience.

Adaptive bitrate (ABR) streaming has become synonymous with Hyper-Text Transport Protocol (HTTP) streaming. At first glance, HTTP does not seem a good fit for a video transport protocol. However, the existing extensive HTTP infrastructure, such as content distribution networks (CDNs), as well as the ubiquity of HTTP support on multiple platforms and devices, makes use of HTTP for Internet video streaming significantly more attractive and more scalable. Yet another factor increasing the attractiveness of HTTP streaming vs. the traditional User Datagram Protocol (UDP) based approach is firewall penetration. While many firewalls disallow UDP traffic, video over HTTP will be typically available behind firewalls. These are some of the factors that make HTTP streaming the technology of choice for rate-adaptive streaming.

In HTTP adaptive streaming, an asset is segmented, either virtually or physically, and published to CDN's. All intelligence resides in the client, which acquires knowledge of the published alternative encodings (representations) and the way to construct Uniform Resource Locators (URLs) to download a segment from a given representation. An ABR client also observes network conditions, and decides which combination of bitrate, resolution, etc., will provide best quality of experience on the client device at each specific instance of time. As the client determines the optimal URL to use, it issues an HTTP GET request to download a segment.

The Dynamic Adaptive Streaming over HTTP (DASH) protocol has evolved to enable ABR streaming as a protocol built on top of the ubiquitous HTTP/TCP/IP stack. The DASH protocol defines a manifest format, the Media Presentation Description (MPD), and segment formats for ISO Base Media File Format and MPEG-2 Transport Streams. DASH also defines a set of quality metrics at network, client operation, and media presentation levels. This enables an interoperable way of monitoring Quality of Experience and Quality of Service.

As noted, the DASH protocol defines several basic formats and constructs, such as the MPD and segment formats. A representation is a basic construct of DASH, defined as a single encoded version of the complete asset, or of a subset of its components. A typical representation would be, for example, in the ISO Base Media File Format (BMFF) containing un-multiplexed 2.5 Mbps 720p AVC video. An asset may include separate ISO-BMFF representations for 96 Kbps MPEG-4 AAC audio in different languages. Conversely, a single transport stream may communicate an asset containing video, audio and subtitles in a single multiplexed representation. A combined structure is possible: video and English audio may be a single multiplexed representation, while Spanish and Chinese audio tracks are separate un-multiplexed representations.

A segment is the smallest individually addressable unit of media data. The segment is typically the entity that is downloaded using URLs advertised via the MPD. One example of a media segment is a 4-second part of a live broadcast, which starts at playback time 0:42:38, ends at 0:42:42, and is available within a 3-min time window. Another example of a media segment is a complete on-demand movie, which may be made available for the whole period this movie is licensed.

The MPD itself is an XML document that presents a hierarchy, starting from global presentation-level properties (e.g., timing), continuing with period-level properties, and adaptation sets available for that period. Representations are the lowest level of this hierarchy. At the representation level, MPD signals information such as bandwidth and codecs required for successful presentation, as well as ways of constructing URLs for accessing segments. Additional information can be provided at this level, starting from trick mode and random access information to layer and view information for scalable and multiview codecs to generic schemes, which should be supported by a client wishing to play a given representation.

Different representations of the same asset (and same component, in the un-multiplexed case) are grouped into adaptation sets. All representations within an adaptation set will render the same content, and a client can switch between them, if it wishes to do so. An example of an adaptation set would be a collection of 10 representations with video encoded in different bitrates and resolutions. It is possible to switch between each one of these at a segment (or even a sub-segment) granularity, while presenting same content to the viewer.

A period, is a time-limited subset of the presentation. All adaptation sets are only valid within the period, and there is no guarantee that adaptation sets in different periods will contain similar representations (in terms of codecs, bitrates, etc.). An MPD may contain a single period for the whole duration of the asset. It is possible to use periods for ad markup, where separate periods are dedicated to parts of the asset itself and to each advertisement.

The DASH protocol provides for Events in an MPD. As HTTP is stateless and client-driven, “push”-style events can be emulated using frequent polls. In current ad insertion practice in cable/IPTV systems, upcoming ad breaks are signaled 3-8 sec. before their start. Thus a straightforward poll-based implementation would be inefficient, and events were designed to address such use cases.

Events are “blobs” with explicit time and duration information and application-specific payloads. Inband events are small message boxes appearing at the beginning of media segments, while MPD events are a period-level list of timed elements. DASH defines an MPD validity expiration event, which identifies the earliest MPD version valid after a given presentation time.

DASH is inherently client-driven, due to the nature of HTTP 1.1. Presently, a DASH session has a single “source”—i.e., there is one “master” source of media and one “master” source of MPDs. The new version of MPD (or new Period element resolved via XLink) is sufficient for a single asynchronous (i.e., unanticipated) switch, in the XLink case it is possible also to indicate the length of the time for such a switch. DASH inband events were created for this case, however events are not targeted—i.e., media is the same for N clients, while only M≦N of them actually need to switch. This means that several versions of content are needed, some with events, some without events, and some with different event timing. This means that events need to be inserted “on the fly” at the edge server in order to preserve cacheability.

There is a need in the art for systems and methods of streaming media to client media playback devices that allow for server control of the media played by the client device.

### SUMMARY

Methods and systems are described for providing server-controlled media sessions. A server generates a media playlist comprising at least one substitute media source indicator indicating a network location of a corresponding substitute media presentation. The media playlist is sent to a media player device to instruct the media player device to interrupt playback of a currently playing media presentation and to playback the substitute media presentation. The server may send the media playlist as a tiered media list in which the tiers are sent separately such that the playback device processes each tier as an individual presentation. The server may also send the media playlist as a stacked playlist to process the stacked playlist as a list of presentations.

A media player device is described for performing server-controlled playback of media. The media player device receives a substitute media source indicator indicating a network location of a substitute media presentation. The media player device sends a request for the substitute media presentation to the network location indicated by the substitute media source indicator. The media player receives the substitute media presentation and stops playback of the currently playing media presentation. The substitute media presentation is then played. Playback of the substitute media presentation may be at a specified time. When playback of the substitute media presentation ends, playback of the main media presentation that was preempted may be resumed.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

A more detailed understanding may be had from the following description, presented by way of example in conjunction with the accompanying drawings, which are first briefly described below.

FIG. 1 is a block diagram illustrating an example of a system for providing server-controlled media streaming to a media player device.

FIG. 2 is a flowchart illustrating operation of server control of a media streaming session on a media player device.

FIG. 3 is a flowchart illustrating operation of server control using tiered media playlists.

FIG. 4 is an example of a media playlist for controlling media playback in a media player device in an XML format.

FIG. 5 is a flowchart illustrating operation of server control using stacked media playlists.

FIG. 6A is a block diagram of an example of a media player device configured to playback media under server control.

FIG. 6B is a block diagram of an example of a media player device configured to perform media streaming according to the DASH protocol.

FIG. 7A is a flowchart illustrating operation of a media player device configured for server-controlled media streaming sessions.

FIG. 7B is a flowchart illustrating operation of the media player device of FIG. 7A in which a second presentation is provided by a server.

FIG. 7C is a flowchart illustrating operation of a stopped media presentation in stop mode and in background mode.

FIG. 7D is a flowchart illustrating operation of the media player device of FIG. 7A in which an event parameter is in a media playback request.

FIG. 7E is a flowchart illustrating operation of a server-controlled session involving an event parameter with event attributes indicating which events are to be monitored.

FIG. 7F is a flowchart illustrating operation of server-controlled session in a media playback device configured to process stacked media playlists.

FIG. 8 is a diagram illustrating an example wireless transmit/receive unit (WTRU) that may be used to embody a DASH client having a DASH server command processor.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application. For example, example implementations are described below in the context of the DASH protocol and other protocols used in streaming media to media playback devices. Example implementations are not limited to using the DASH protocol or any other protocol specified in the description below. Server-controlled sessions may be implemented according to any suitable scheme for media streaming that is controlled by the client device.

As used herein, the term “media presentation” shall refer to any media construct presented to a media playback device for initiation of a media streaming session. A Media Presentation Description (“MPD”) is one example of a media presentation formatted according to the DASH protocol.

As used herein, the term “event” shall refer to a timed element of information, such as a message or a cue, relating to a part of a media presentation (such as a movie or an advertisement), that has been embedded into the presentation media (such as bitstreams, segments or manifests). A DASH event is one example of an event implemented according to the DASH protocol.

Other terms having a definition under the DASH protocol or any other protocol referenced herein shall be understood to have a broader meaning in the context of this specification unless explicitly stated otherwise.

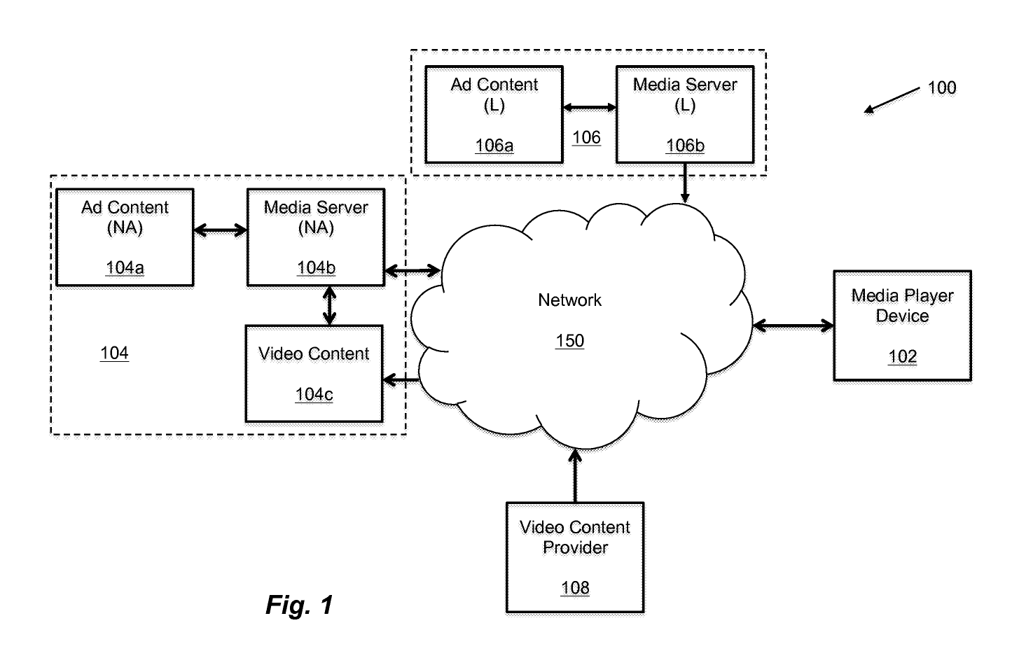

FIG. 1 is a block diagram illustrating an example of a system 100 for providing server-controlled media streaming to a media player device 102. The system 100 comprises a national media provider 104, a local media provider 106, and a video content provider 108 communicating with the media player device 102 over a communications network 150 (e.g. the Internet). The media player device 102 operates as a client device in a streaming media session with a server and may be any suitable device with a display and audio outputs configured to communicate over the communications network 150. Examples of media player devices 102 include, without limitation, a wide variety of wired communication devices and/or wireless transmit/receive units (WTRUs), such as, but not limited to, digital televisions, wireless broadcast systems, a network element/terminal, servers, such as content or web servers (e.g., such as a Hypertext Transfer Protocol (HTTP) server), personal digital assistants (PDAs), laptop or desktop computers, tablet computers, digital cameras, digital recording devices, video gaming devices, video game consoles, cellular or satellite radio telephones, digital media players, and/or the like.

The national media provider 104 includes an ad content server 104a, a national media server 104b, and a video content server 104c. The national media server 104b retrieves ad content from the ad content server 104a for streaming to advertisements to the media player device 102. The national media server 104b may be configured to format media presentations for transmission to the media player device 102. The national media server 104b may retrieve video content in the form of media presentations comprising content that may be requested by a user for transmission to the user at the media player device 102. The national media server 104b may obtain advertisement media that is of local interest to the user from the local media provider 106. In an example implementation, the national media server forms media playlists that include a substitute media source indicator that indicates a substitute media presentation to be transmitted to the media player device 102 while the media player device 102 is playing a main presentation, such as, for example, a user-selected media presentation (such as, video-on-demand [VOD] or a live video stream ordered or requested by a user of the media player device).

The main media presentation may be provided to the user by another server, such as for example, a server operating under the video content provider 108. In example implementations, the national media server 104b configures media playlists including the main media presentation and at least one substitute media presentation. The substitute media presentation may include advertisements (such as targeted ads), public service announcements, emergency alerts, media blackouts, or any other suitable media.

The local media provider 106 includes a local ad content server 106a and a local media server 106b. In an example implementation, the local media server 106b may communicate local ad media from the local ad content server 106a to the national media provider 104 for inclusion in a media playlist.

It is to be understood that the term “national” is merely a term indicating one level of a hierarchy. Thus, the term national may refer to a content associated with a geographical region (a nation, a time zone, a city, a broadcast area, etc.), or a source associated with some other hierarchical division according to market segments, audiences, service providers, subscriber levels, etc. Similarly, the term “local” is intended to refer to a next level down in the hierarchy. The network may be a wireline connection or a wireless connection or a combination thereof

The communications network 150 may be any suitable communication network. For example, the communications network 150 may be a multiple access system that provides content, such as voice, data, video, messaging, broadcast, etc., to multiple wireless users. The communications network may enable multiple wireless users to access such content through the sharing of system resources, including wireless bandwidth. For example, the communications network 150 may employ one or more channel access methods, such as code division multiple access (CDMA), time division multiple access (TDMA), frequency division multiple access (FDMA), orthogonal FDMA (OFDMA), single-carrier FDMA (SC-FDMA), and/or the like. The communication network 150 may include multiple connected communication networks. The communication network 150 may include the Internet and/or one or more private commercial networks such as cellular networks, WiFi hotspots, Internet Service Provider (ISP) networks, and/or the like.

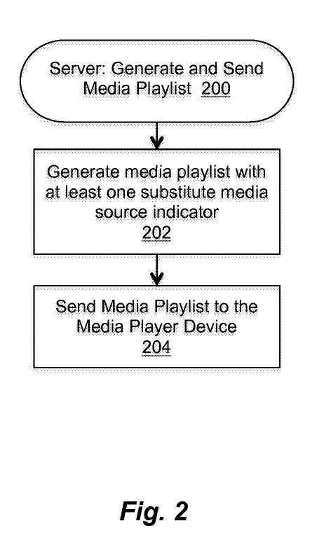

In an example implementation, a server, such as for example, the national media server 104b, may be configured to generate media playlists for playback by a media player device (102 in FIG. 1). FIG. 2 is a flowchart 200 illustrating operation of server control of a media streaming session on a media player device 102 (in FIG. 1). A server, such as for example, the national media server 104b in FIG. 1, generates a media playlist including at least one substitute media source indicator at step 202. The media playlist is then communicated to the media player device 102 at step 204. The media playlist in the context of this specification shall refer to a sequence of media playback requests communicated to the media player device 102 as a set, or individually as single media playback requests. As such, a single media playback request comprising a substitute media source indicator may be a list having a single element where the substitute media source indicator is communicated to the media player device 102 playing streaming media.

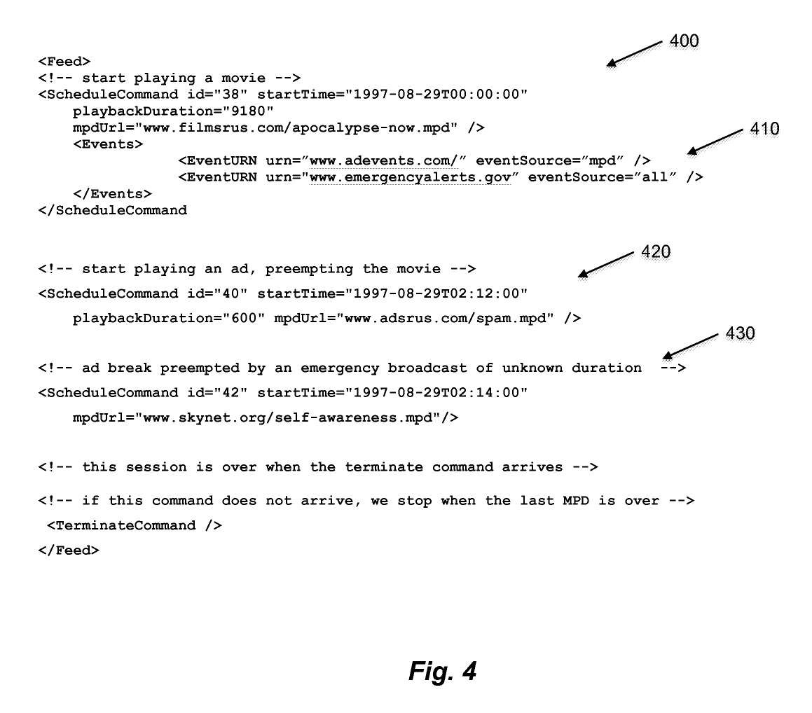

In an example implementation, the media playlist includes the at least one substitute media start time with a corresponding substitute media start time indicating a time for the media player device 102 (in FIG. 1) to begin playback of the substitute media presentation. The substitute media playback time may be provided as a parameter of the substitute media source indicator, or of a command and the substitute media source indicator as described further below with reference to FIG. 4.

In some embodiments, a player state may be expressed by a tuple of parameters include a media source indicator and the playback time. In the context of the DASH protocol, the tuple of parameters may include a MPD URL as the media source indicator, a time within that MPD, and adaptation sets being played. The DASH protocol provides MPD anchors, which provide the media source location, start time and adaptation sets information using URI fragment notation. Beyond player state, time range (i.e., a time-delimited subset of the MPD) can be expressed using the t parameter of the MPD URL.

In one embodiment, the server may transmit a “feed” of tuple parameters such that each media source indicator received by the media player device causes the media player device to switch to a new player state. In further embodiments, a protocol may be configured to provide a “pre-roll”—i.e., where an explicit notion of switch time is known. This implies a “feed” containing at least tuples (MPD URL, playback start time). In these and other embodiments, a playback start time may be either absolute (e.g. UTC) or relative (in seconds).

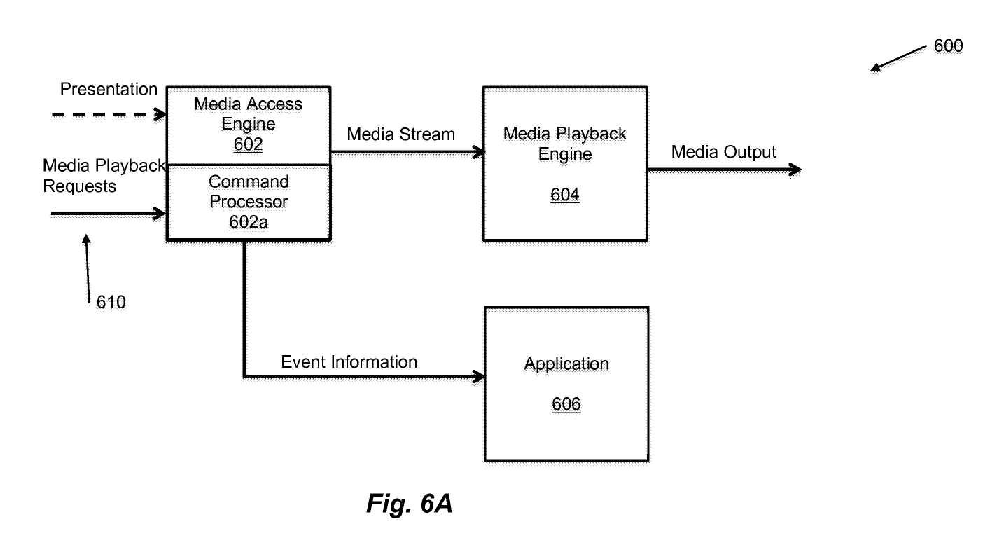

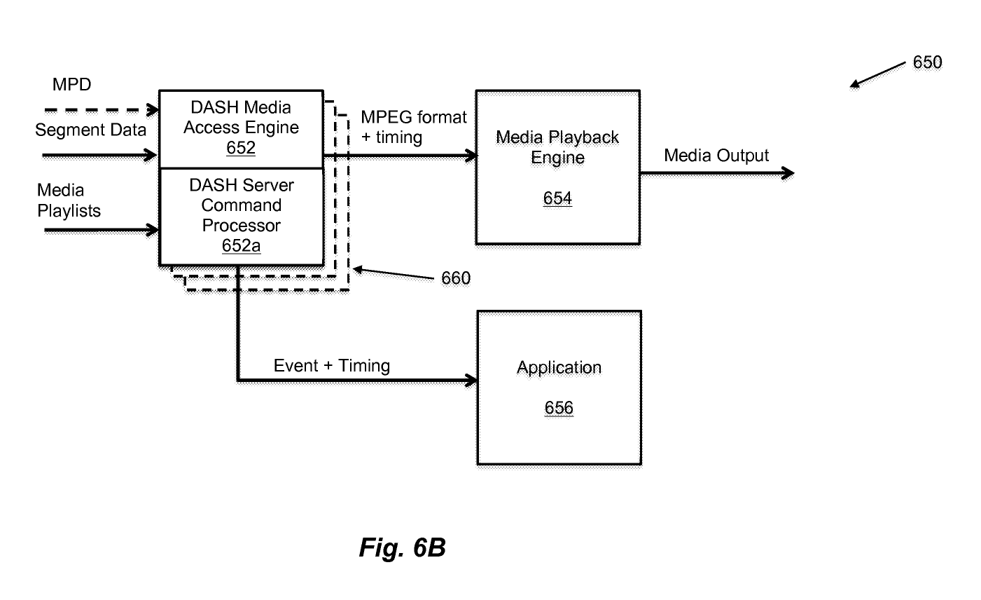

Further, a feed may also contain a processing instruction for the media player device, which may include a command processor to process the instructions as described below with reference to FIGS. 6A and 6B. In these embodiments, a data stream referred to herein as a “feed” contains tuples having the following parameters (media source indicator, playback start time, instruction). Such instruction, or commands, may be to conserve the currently playing state of media presentation. For example, in a DASH implementation, the currently playing state of media presentation, MPD(n) (which is being pre-empted by the new instruction) is conserved and then resumed when presentation of the new media presentation (MPD(n+1)) is completed by the DASH client. In some embodiments, the client device stores and manages a stack of player states, either at the client or at the server. In some embodiments, the client may detect a failure of the media presentation data stream (e.g., MPD(n) in DASH) and automatically revert to the interrupted media presentation data stream (e.g., MPD(n−1) in DASH) by reading the stored state tuple and restoring playback of the prior media presentation, thereby providing a relative resilience to failures.

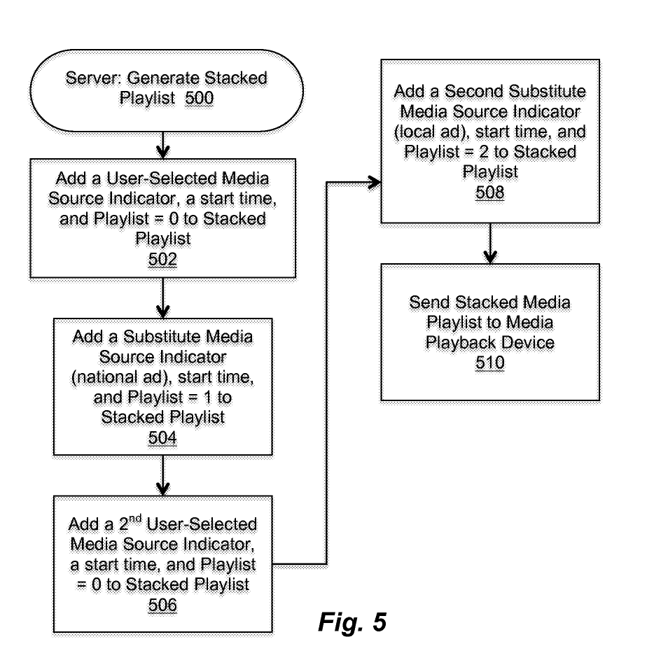

A media server, such as, for example, the national media server 104b in FIG. 1 may signal server-side media feeds by generating media playlists comprising tuples, or media playback requests, or any other form of representing a player state, according to various example embodiments. These example embodiments, by way of example only, may be used in a scenario of tiered ad insertion, where a first content such as a football game, MPD(F), starts at time TS(F) and is interrupted by MPD(NA) (national ads), the latter being interrupted by MPD(L) (local ads). TS(NA) is the time at which MPD(NA) starts and it ends at TE(NA). Similarly, local ads start at TS(L) and end at TE(L). Media playlists may be tiered media playlists in which tuples, or media playback requests, or any other form of representing a player state, may be communicated to the media playback device individually. In another example embodiment described with reference to FIG. 5, a stacked playlist may be provided to the media playback device.

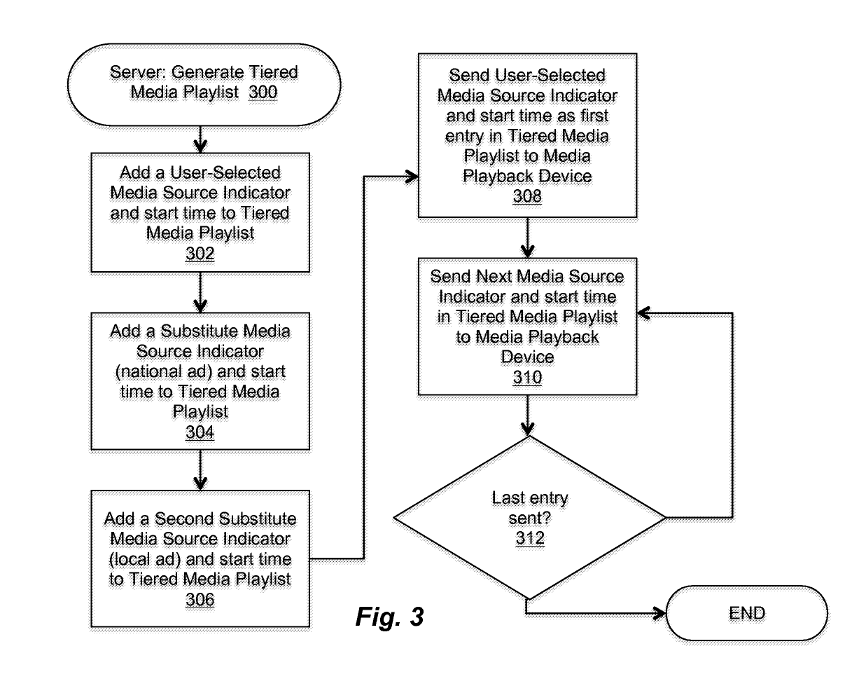

FIG. 3 is a flowchart 300 illustrating operation of server control using tiered media playlists. The tiered media playlist may include at a top tier, a main media source indicator that indicates a network location of a main media presentation in step 302. In an example implementation, the tiered media playlist may be formed by a server that is to deliver a media presentation selected by the user. The main media source indicator may be an MPD URL in a DASH implementation. The server may then add, in step 304, a substitute media source indicator and substitute media start time to the tiered media playlist. The substitute media source indicator indicates a network location (e.g., an MPD URL in a DASH implementation) of a substitute media presentation, which would interrupt playback of the main media presentation at the media player device. The substitute media presentation may be, for example, an advertisement, such as an ad on a national level. In step 306, a second substitute media source indicator and second substitute media start time is added to the tiered media playlist. The second substitute media source indicator indicates a network location of a substitute media presentation, which would interrupt playback of either the substitute media presentation or the main media presentation at the media player device.

The entries in the tiered media playlist are communicated to the media playback device individually. The transmission of each entry may be separated by selected time intervals, or the tiered media playlist may be formed as entries are transmitted to the media playback device thereby providing the server with control over a period of time. In step 308, the first entry of the tiered media playlist containing the main media source indicator and start time is transmitted. In step 310, after the main media presentation has started playing, the next entry in the tiered media playlist containing the next media source indicator is transmitted to the media playback device. The server may periodically check if the last entry in the tiered media playlist has been reached at decision block 312. If not, step 310 is repeated to transmit the next entry in the tiered media playlist. If not, the process of generating the list and transmitting the list to the media playback device may be ended. The end of the process may be indicated, for example, by the end of the playback of the main media presentation.

As described above, a media playlist may be generated by forming a list of tuples each corresponding to one of the substitute media presentations indicated by the substitute media source indicators in the media playlist. Each tuple may be formed by the substitute media source indicator, and a command parameter, where the command parameter instructs the media player device in processing the substitute media presentation indicated by the substitute media source indicator in the tuple.

In the context of a DASH implementation, a tuples playlist may comprise a list of MPD URLs and commands, where some embodiments may also include a time TP at which the DASH client should play them. The DASH client may process each new arriving MPD URL and responsively terminate the currently running presentation at time TP. The sequence of commands transmitted by the DASH server in an example DASH implementation is shown in Table 1.

TABLE 1

| Command | MPD | Time | Client action |
|---|---|---|---|
| schedule | MPD(F) | TS(F) | Start playing MPD(F) at time 0 |
| schedule | MPD(NA) | TS(NA) | Stop playing MPD(F) and switch to |
| | | | MPD(NA) at time TS(NA). |
| schedule | MPD(L) | TS(L) | Stop playing MPD(NA) and switch to |
| | | | MPD(L) at time TS(L). |
| schedule | MPD(NA) | TE(L) | Stop playing MPD(L) and start playing |
| | | | MPD(NA) at time TE(L) |
| schedule | MPD(F) | TE(NA) | Stop playing MPD(NA) and start |
| | | | playing MPD(F) at time TE(NA). If this |
| | | | is live, MPD(F) will start at the “live |
| | | | edge”, if this is on-demand (i.e., pre- |
| | | | recorded), MPD(F) needs to start from |
| | | | the same point where it was interrupted, |
| | | | and the correct time offset (TS(NA)- |
| | | | TS(F)) will be a part of the MPD URL |
| | | | or will be separately provided. |

An example media playlist may be formatted as a sequence of XML elements transmitted to the media playback device. FIG. 4 is an example of a media playlist for controlling media playback in a media player device in an XML format for a DASH implementation. The media playlist illustrated in FIG. 4 may be generated when a user selects the indicated media presentation for playback on the media playback device. The media playlist includes a first XML element 400 comprising a schedule command, a start time, a playback duration, an MPD URL, and an events parameter 410. The first XML element 400 instructs the media playback device to schedule playback of the media presentation at MPD URL www.filmsrus.com/apocalyse-now.mpd, which is a media presentation for the film “Apocalypse Now.” Playback of the film is to be scheduled for Aug. 29, 1997 at midnight.

The Event parameter 410 instructs the media playback device on handling events in the media presentation scheduled for playback in the first XML element 400. In general, events are messages embedded in the media portions of a media presentation. In DASH implementations, application-driven ad insertion (e.g., according to DASH-IF-IOP-v3.0) in live content provides a use case where MPD playlists cannot effectively provide server-side session control. For example, the main content (e.g., media content delivered to the client in DASH segments) contains cue messages (e.g., SCTE 35 cue messages) inserted several seconds before an ad break. The cue messages trigger ad requests and eventually result in the application pausing the DASH client playing the main content and starting a DASH client (e.g., another instance of the DASH client), which plays an ad. Cue messages are transported in the main content, and events embedded in the main content while the DASH client presenting it is paused may not reach the application. This means that messages requiring interruption of current ad—e.g., emergency broadcast or schedule change cutting the ad break short—may never reach the client, as segments containing these cue messages would never be downloaded.

The Event parameter 410 is included to provide a way of ensuring that DASH events in the media presentation are not missed in the event that playback of the media presentation indicated in the XML element 400 is interrupted by a substitute media presentation. The Events parameter 410 identifies events with uniform resource names (URN) of www.adevents.com and www.emergencyalerts.gov as events in the media presentation that are to be monitored even if playback of the media presentation in the first XML element 400 is preempted. The Events parameter 400 further includes an event source parameter indicating the type of events that should be monitored. Events from URN www.adevents.com are to be monitored if the events are MPD events. All events from URN www.emergencyalerts.gov are to be monitored, which in a DAH implementation would mean that MPD and inband events associated with URN www.emergencyalerts.gov are to be monitored.

The media playlist includes a second XML element 420 comprising a schedule command, a start time, a playback duration, and an MPD URL. The second XML element 420 is an example of a tuple for transmission of a command to schedule a substitute media presentation that preempts playback of the main media presentation indicated in the first XML element 400. The media playlist also includes a third XML element 430 comprising a schedule command, a start time, and an MPD URL.

The second XML element 420 instructs the media playback device on playback of a national ad from www.adsrus.com/spam.mpd at the indicated time for the specified playback duration. As noted above, the indicated time is set to interrupt playback of the main media presentation. The third XML element 430 instructs the media playback device on playback of a local ad from www.skynet.org/self-awareness.mpd. The indicated start time of playback of the local ad is set to interrupt playback of the national ad in the second XML element 420.

In the example illustrated in FIG. 4, when the ad (spam.mpd in the second XML element 420) begins playing, it preempts playback of the main movie (apocalypse-now.mpd in the first XML element 400). Playback of the main movie is then paused. However, while apocalypse-now.mpd is paused, time on its timeline still passes, and the associated player instance continues to monitor events (such as advertising events from www.adsource.com, as well as emergency alert events from www.emergencyalerts.gov.)

The session specified by the media playlist in FIG. 4 may be ended when the last media presentation playing is over, or by execution of the Terminate command, which instructs the media playback device to shut down playback of the playing media presentation.

In some embodiments, another instruction is a “replace” command, which instructs the media player device to replace a given media presentation (e.g., MPD(i) in a DASH implementation) with a different media presentation (e.g., MPD′(i) in a DASH implementation) so that whenever an interrupting media presentation (e.g., MPD(i+1) in a DASH implementation) is finished, then playback will return to different media presentation (e.g., MPD′(i)) rather than the previously stored media presentation (e.g., MPD(i)). In this embodiment, the replace command is processed by the media player device by replacing the state information associated with the given media presentation (e.g., MPD(i)) with a different state associated with the different media presentation (e.g., MPD′(i)).

Media playback requests, or tuples, or other feed elements of a media playlist may include commands and/or parameters related to security. One problem associated with using events for providing server-controlled sessions is the potential for a man-in-the-middle attack. In some embodiments, a media presentation signature may be embedded in the same feed as the media source indicator. Where the feeds are transmitted as XML elements, a signature may use the XML Signature syntax.

The example in FIG. 4 illustrates transmitting feeds as XML elements. Feeds may be specified in other formats, such as, for example, the JSON or key-value pair list formats as described in more detail below.

Tiered media playlists were described above with reference to FIG. 3 as media playlists where feeds are transmitted as individual elements to the media player device. In another example embodiment, a feed may comprise a stack, or prioritized list of stored parameters, used to manage the playback sequence at the media player device. In the embodiments using a stack construct, each media presentation (e.g., MPD URLs (possibly including a time TP parameter) in a DASH implementation) interrupts the operation of the currently playing media presentation, and come back to it once the new media presentation is in place. FIG. 5 is a flowchart 500 illustrating operation of server control using stacked media playlists.

In an example implementation, the stacked media playlist may be generated by a server when the user of the media player device requests playback of a media presentation. The server may assert control over the session by adding media playback requests that may for example provide targeted ad insertion or other features. In example embodiments, stacked playlists are signaled by the server to provide session control, and are processed in the media player device. As an example scenario where a stacked-playlist embodiment may be used implementing the DASH protocol, an MPD(F) may end somewhere in the time interval between TS(NA) and TE(NA), and when we are returning from MPD(NA) we can no longer return to MPD(F) but instead should return to MPD(F1). This may provide identifiable slots, where playlists, as described above are embedded within the stack. In the DASH example, the server signals that MPD(F1) replaces MPD(F) at time TS(F1) and TS(NA)<TS(F1)<TE(NA).

Referring to FIG. 5, at step 502, a main media source indicator and start time are added to the stacked playlist at the top of the stack. A new parameter, a playlist level parameter, may be added to the media playback request as shown in step 302 of FIG. 5. The playlist level parameter indicates a level distinguishing the media presentations indicated by the at least one main media source indicator from the media presentations indicated by the at least one substitute media source indicator. When a media presentation is played back, the media player device updates a current playback level to indicate the level of the media presentation that is to start playing. The playlist level parameter allows the media player device to track the hierarchical level of the media playing at any given time thereby allowing the media player device to manage playback of media, such as user-selected media, particularly when the timeline of the media is affected by media that preempts its playback.

At step 504, a substitute media source indicator and start time are added to the stacked playlist along with a playlist level parameter indicative of substitute media. The playlist level parameter is set to 0 for the main media presentation added in step 502. The playlist level parameter is set to 1 for the substitute media presentation added in step 504. When the substitute media presentation interrupts the main media presentation and is played back by the media player device, the playlist level indicator in the media player device is set to 1 (for purposes of the example stacked playlist described with reference to FIG. 5). The playlist level indicator with a value of 1 indicates to the media player device that the currently playing media is a substitute media presentation and the main media presentation may be playing in background mode.

At step 506, a media playback request comprising a second main media source indicator, start time and playlist level parameter (with a value of 0) is added to the stacked playlist. The media player device may monitor the timeline of a preempted main media presentation by processing the preempted main media presentation in the background. If the time reaches the start time indicated for the second main media presentation, the media player device may tear down the first main media presentation and process the second media presentation in the background (no display or audio output).

At step 508, a media playback request comprising a second substitute media source indicator, start time, and playlist level parameter (with a value of 2) is added to the stacked playlist. At step 510, the complete stacked playlist is sent to the media player device.

Table 2 illustrates how a media player device may process a stacked playlist.

TABLE 2

| Command | MPD | Time | Client action |
|---|---|---|---|
| schedule | MPD(F) | TS(F) | Start playing MPD(F) at time 0 |
| schedule | MPD(NA) | TS(NA) | Pause MPD(F) and switch to MPD(NA) at |
| | | | time TS(NA). |
| | | | When done, switch back to MPD(F) |
| schedule | MPD(L) | TS(L) | Pause MPD(NA) and switch to MPD(L) at |
| | | | time TS(L). When MPD(NA) done, switch |
| | | | back to TS(NA) (i.e., previous item on the |
| | | | stack). |

The sequence of server-side issued command and data stream parameters in an example using a playlist level parameter are shown below in Table 3.

TABLE 3

| Command | MPD | Time | playlist | Client action |
|---|---|---|---|---|
| schedule | MPD(F) | TS(F) | 0 | Start playing MPD(F) as playlist 0 at |
| | | | | time TS(F) |
| schedule | MPD(NA) | TS(NA) | 1 | Pause playlist 0 and switch to |
| | | | | MPD(NA) (as playlist 1) at time |
| | | | | TS(NA). |
| | | | | When done, switch back to playlist |
| | | | | 0. |
| schedule | MPD(F1) | TS(F1) | 0 | Tear down session MPD(F), and set |
| | | | | up session MPD(F1) as playlist 0. |
| | | | | Playlist 0 is in a paused state, so |
| | | | | nothing is displayed. |
| schedule | MPD(L) | TS(L) | 2 | Pause MPD(NA) and switch to |
| | | | | MPD(L) as playlist 2 at time TS(L). |
| | | | | When MPD(NA) done, switch back |
| | | | | to playlist 1 |

In some embodiments, resource consumption may be managed particularly in embodiments implementing stacked modes stored in the media player device as it keeps a record of the state parameters of each interrupted session. The media player device may process interrupted media presentations in a background mode. In an example implementation, the background mode may be implemented by generating instances of a player client for each media presentation where only the currently playing instance is active, or connected to a display and/or audio output. The memory required to store the stacked state parameters has the potential to grow and consume more and more memory and other resources. In some embodiments, a limit on the number of slots, or states, that can be occupied may be specified by the media player device. The limit may be obtained explicitly or implicitly derived from the feed data stream at the start of the session.

An example DASH implementation involving multi-period MPDs, where each Period element may be viewed as a playlist item, and periods having the same AssetIdentifier as multiple playlists, may present similar resource consumption issues. That is, if the DASH client keeps track of multiple assets, the resources needed to keep track of all assets will become unreasonably large. The system may be unable to provide an explicit indication of when the asset ends.

To accommodate such a scenario, an example embodiment of the server-side session controller may indicate at the Period level in the MPD whether a given period is the last period of a given asset. In one such embodiment, a parameter referred to herein as SupplementalProperty is associated with the Period level, which will state whether the period is the last one and, in some embodiments, the SupplementalProperty parameter indicates what the start time of the period corresponds to in the asset.

As noted above, a media playlist may be formatted as a sequence of XML elements as illustrated in FIG. 4. A stacked playlist may be an XML document containing a sequence of XML elements. In this regard, FIG. 4 may be viewed as an XML document containing a stacked playlist.

A media playlist may need to be updated. Updates (such as the ScheduleCommand elements described above) will arrive prior to their playback start time. Updating can be done using, for example, the RSS, Atom protocol, HTTP/2.0 or HTTP/1.1 features that allow delayed response, WebSockets, or any other similar protocol allowing server-initiated updates of client-side documents (e.g. using client-side polling or server-initiated push features).

In general, the use of media playlists for server-side session control of a media session may be implemented as an XML element, as a JSON element or as a list of key-value pairs. An alternative implementation of the feed for playing Apocalypse Now illustrated in FIG. 4 using a JSON format, which uses HTML5 Server Sent Events, can be similar to the one below:

event: scheduleCommand
data: { “id” : ″38″, “startTime” : ″1997-08-29T00:00:00″ ,
data: “playbackDuration” : ″9180″
data: “mpdUrl” : www.filmsrus.com/apocalypse-now.mpd }

A set of commands and parameters may be specified to implement a syntax that a media player device may be configured to process. An example syntax for commands that may be used in DASH-based MPD URL playlists of the type described above is illustrated below in Table 4 in the context of playlists configured in an XML-based implementation. The XML representation of a single command will be the ScheduleCommand XML element having the structure and attributes indicated in Table 4 below.

As shown in Table 4, the ScheduleCommand XML element includes an MPD URL attribute, and may also include a unique identifier, a start time, a playback duration, a playlist identifier, and an MPD signature. The attributes are described in Table 4 and may be specified according to XML formatting in any ScheduleCommand XML element in an XML URL playlist. Table 4 also lists parameters and attributes relating to the use of an Event parameter described above with reference to FIG. 4.

TABLE 4

| Element or Attribute | | |
|---|---|---|
| Name | Use | Description |
| ScheduleCommand | | |
| @mpdURL | M | URL of the MPD that is scheduled to play at time |
| | | @startTime for duration @playbackDuration. |
| @id | O | Unique identifier |
| @startTime | OD | Absolute time a which the playback of the MPD |
| | | will start. Immediate if absent. |
| @playbackDuration | OD | Time duration for which the MPD should be |
| | | played. Till the end of the presentation, if absent |
| @playlistId | OD | Id of the playlist (or stack) if multi-playlist/multi- |
| | | stack implementation is used. If absent, the default |
| | | value is 0. |
| @pausedBehavior | OD | If the value is “stop”, the player will stop when a |
| | | different MPD is playing, and the presentation time |
| | | (relative to presentation start) when resumed will be |
| | | same as when it was paused. |
| | | If the value is “background” there will be no |
| | | decoding and display (e.g. while a different MPD is |
| | | playing), but time will pass, the MPD to which this |
| | | instance of ScheduleCommand applies may be |
| | | updated and segments may be downloaded. Events |
| | | may be monitored and/or processed, as specified by |
| | | the “Events” field (see below). If paused at time T |
| | | (relative to presentation start) for d seconds, the |
| | | time at resume will be T + d. |
| | | Note that “stop” is a behavior typical for VOD, |
| | | while “background” is typical for live broadcast. |
| MpdSignature | 0..1 | Digital signature of an MPD that can be |
| | | downloaded at the URL contained in @mpdUrl. |
| | | This element may contain the W3C XML DSIG |
| | | Signature element described in |
| | | www.w3.org/TR/2008/REC-xmldsig-core- |
| | | 20080610/or a new element containing a signature |
| | | e.g. as a hash or a message authentication code |
| | | (MAC) |
| Events | 0..N | Which event(s) need to be monitored and/or |
| | | processed. |
| @all | 0 | If true, all events should be monitored, even if not |
| | | listed in EventURN element below |
| EventURN | 0..N | |
| @urn | M | URN of the event |
| @eventSource | OD | Source of the events |
| | | If “mpd” then events monitored are only MPD |
| | | events. If “inband” then only inband events are |
| | | monitored. If “all” then all events (e.g. both MPD |
| | | events and inband events) are monitored. |
| | | Default value is “all”. |

Legend:
For attributes:
M = Mandatory,
O = Optional,
OD = Optional with Default Value,
CM = Conditionally Mandatory.
For elements: <minOccurs>. . .<maxOccurs> (N = unbounded) Elements are bold; attributes are non-bold and preceded with an @

Additional commands may include a “Teardown” command to instruct a playback client to tear down playlists/stacks. If none remain, this will end the session. Note that alternative implementations are possible where this element will be present as an element or attribute in the ScheduleCommand element above. An example XML format for a teardown (or “terminate”) command is described below with reference to Table 5.

TABLE 5

| Element or Attribute | | |
|---|---|---|
| Name | Use | Description |
| TerminateCommand | | If no child elements, terminate all playlists. |
| PlaylistItem | 0..N | |
| @id | OD | Identifier of the playlist to terminate. “0” if absent. |
| @urn | OD | URN of the MPD that needs to be discontinued. If |
| | | absent, all MPDs in a playlist will be discontinued, |
| | | and the playlist will be terminated. |

Legend:
For attributes:
M = Mandatory,
O = Optional,
OD = Optional with Default Value,
CM = Conditionally Mandatory.
For elements: <minOccurs>. . .<maxOccurs> (N = unbounded) Elements are bold; attributes are non-bold and preceded with an @

Feed implementation may be structured according to a number of alternative embodiments. In some embodiments a method or protocol that allows delayed server response may be used. Various embodiments are described below.

One example embodiment uses the HTML5 SSE (server-sent events, http://dev.w3.org/htm15/eventsource/), where a single event line is configured to contain the tuple. In a further embodiment, a data stream may be generated according to HTTP/2.0, using server push messaging. In further embodiments, one or more syndication protocols are used, such as Atom and RSS. In embodiments using the RSS protocol, the tuple is embedded in the “item” attribute. In embodiments using the Atom protocol, the tuple is embedded in the “entry” element. In yet further embodiments, several frameworks for communicating information regarding live program schedules (e.g., CableLabs ESNI [13]) to cloud-based virtual IRDs may be used. In some embodiments, an MPD URL can be used within such a feed. The MPD URL may be used of or in addition to a unique asset identifier.

FIG. 6A is a block diagram of an example of a media player device 600 configured to playback media under server control. The media player device 600 comprises a data network interface configured to send and receive data over a data network. The data network interface is indicated generally in FIG. 6A at reference number 610 and described in more detail below with reference to FIG. 9. The media player device 600 also includes a media access engine 602 configured to communicate requests for media presentations and to receive media playback requests over the data network via the data network interface, a media playback engine 604 configured to receive a media stream contained in a currently playing media presentation and to communicate the video to a display device, a command processor 602a and a non-transitory computer-readable medium storing executable instructions for performing server-controlled media streaming functions. The media playback engine 604 may also communicate audio to an audio output device.

In operation, the command processor 602a receives media playback requests communicated to the data network interface 610 of the media player device 600. The command processor 602a processes the media playback requests communicated for server session control based on the format used for the media playback request. For example, the command processor 602a would parse XML elements in the media playback request if the media playback request is communicated as one or more XML elements. The XML elements, or elements in whatever format is used, may also be communicated in, for example, an RSS feed and the media playback device 600 will need to be configured to extract the media playback requests from such feeds.

The processing of the media playback requests may involve identifying parameters and attributes (such as for example commands and parameters listed in Table 4 above) that may be specified in the media playback requests. For example, in the example of the media playback requests illustrated in FIG. 4 above, parameters of the schedule command including the start time, play duration, and the event parameter and attributes specified in the first XML element 400 are identified and stored as characteristics of the media presentation indicated in the media playback request.

The media access engine 602 receives media presentations and portions of the media as playback proceeds as dictated by the media presentation. The media access engine 602 decodes the media data and generates a media stream that is communicated to the media playback engine 604.

Operation of the media access engine 602 and command processor 602a may be controlled by an application 606 operating in the media player device 600. In general, the application 606 provides the context under which the media access engine 602 and media playback engine 604 operate. For example, the application 606 may be a video-on-demand (VOD) player application. The user may invoke operation of the video-on-demand application and the application creates instances of the media access engine 602 as needed to receive the media presentation for the asset selected by the user. The application 606 may also be browser window connected to a live performance. The application 606 creates instances of the media access engine 602 to retrieve the media presentation for playback live. In general, the user would select the application 606 with a user interface as well as the media asset that the user would like to view. The user invokes the suitable application 606 to play the main media presentation.

In some embodiments, the application 606 may create instances of the media access engine 602. Instances of the media access engine 602 may also be created as needed. For example, multiple instances of the media access engine 602 may be used to provide parallel decoding of a given media presentation. The application 606 may also be used to process events similar to event processing in a DASH media player device.

FIG. 6B is a block diagram of an example of a media player device 650 configured to perform media streaming according to the DASH protocol. The DASH media player device 650 includes a DASH media access engine 652, a DASH server command processor 652a, a media playback engine 654, and an application 656. In a DASH implementation, the DASH server command processor 652a receives media playlists configured as described above with reference to FIGS. 1-5 and Tables 1-4.

The DASH media access engine 652 (also referred to as a DASH client) receives MPDs and segment data and processes the MPDs and segment data to generate and communicate media to the media playback device 654. As shown in FIG. 6B, the media communicated to the media playback engine 654 will typically conform to the MPEG format and include timing information. The DASH media access engine 652 may operate as instances 660 of a media engine, such that at least one instance 660 of the DASH media access engine 652 is created for each media presentation received. The server control of the media playback may then be carried out by exercising control of the player state associated with each instance. An instance of the media access engine 652 may be in an active state receiving media and communicating media streams to the media playback engine 654. Other instances may be in a paused state in which the instance of the media access engine 652 continues to receive media data, and the timeline of the instance of the media access engine 652 is monitored. Instances of the media access engine 652 may also be stopped so that the timeline of the media presentation is not monitored and the media is not displayed.

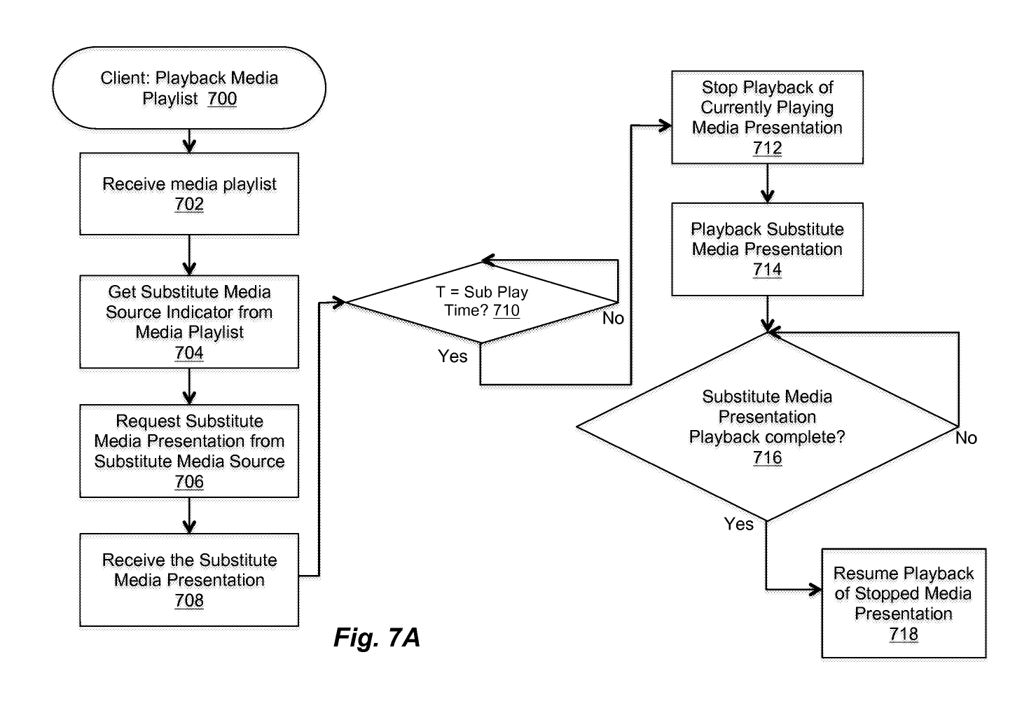

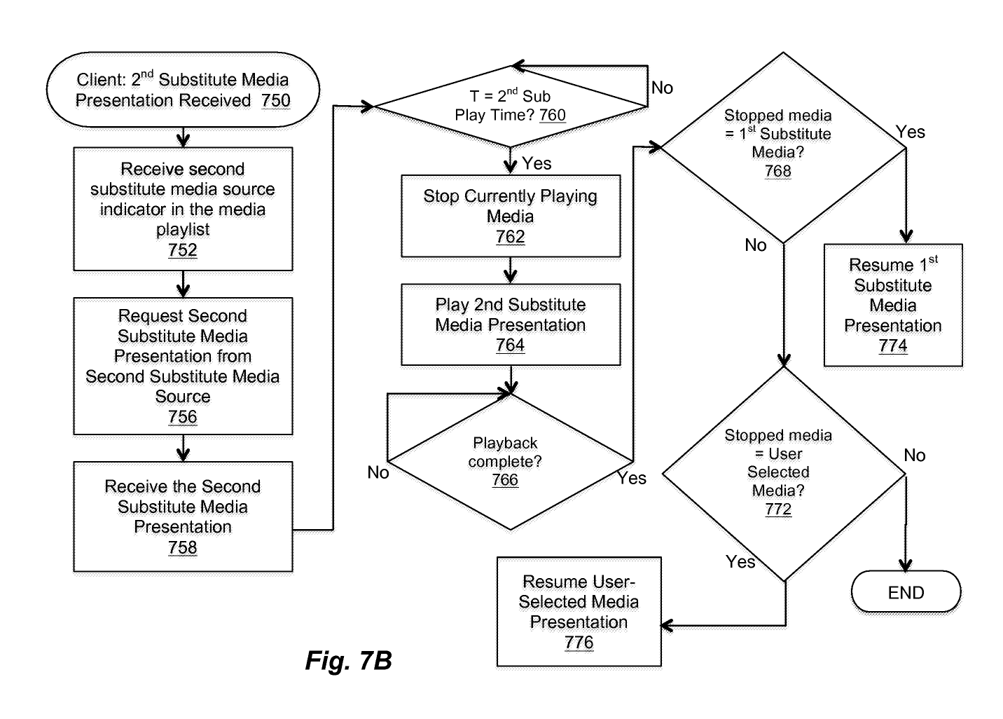

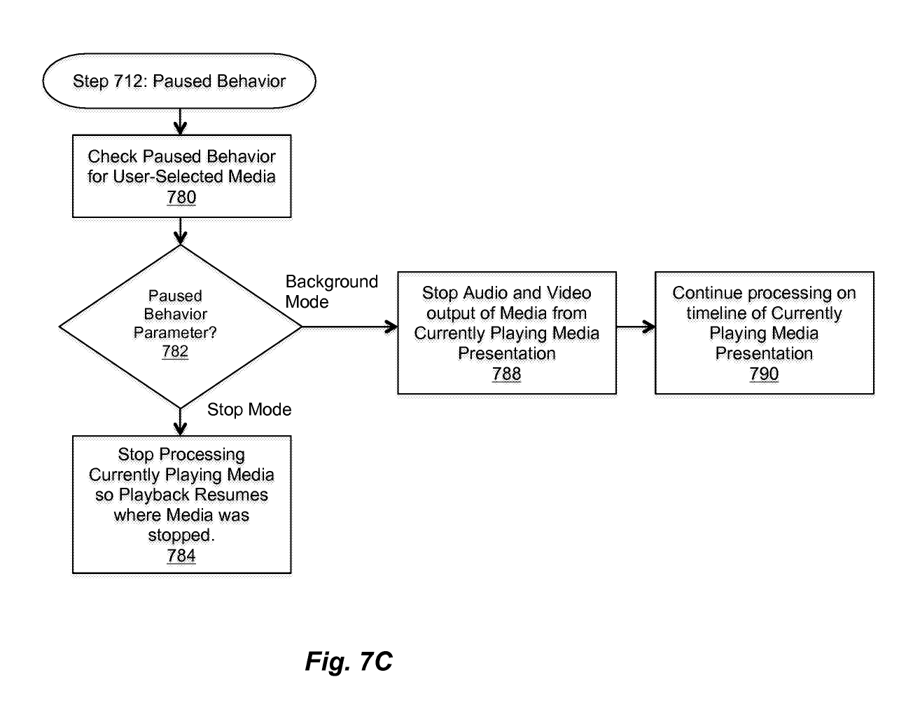

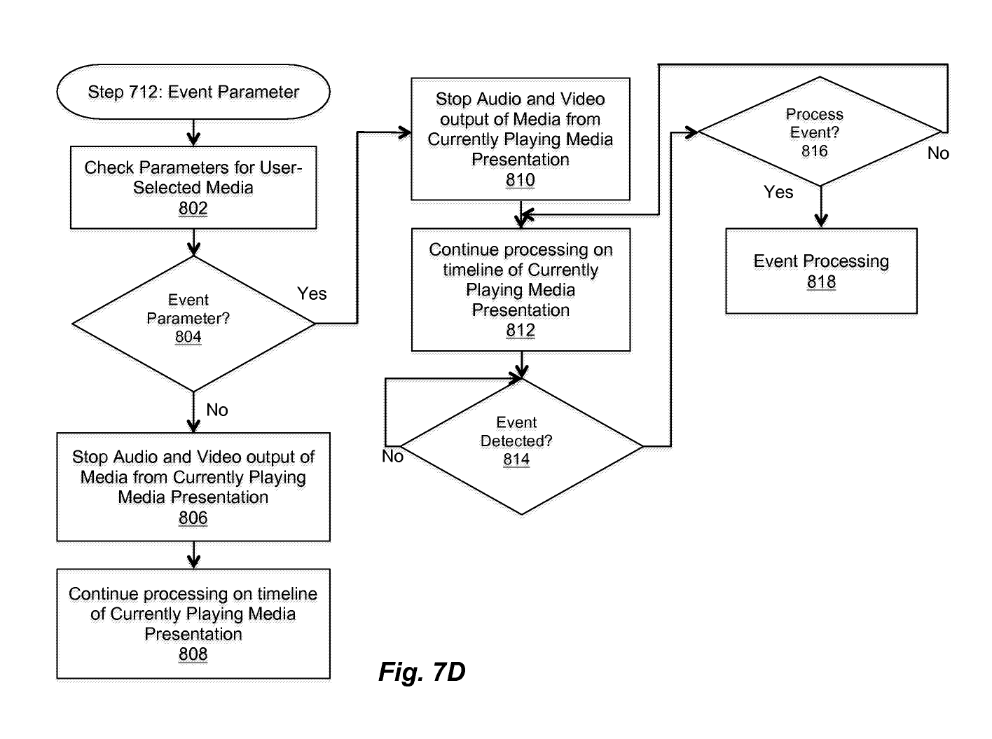

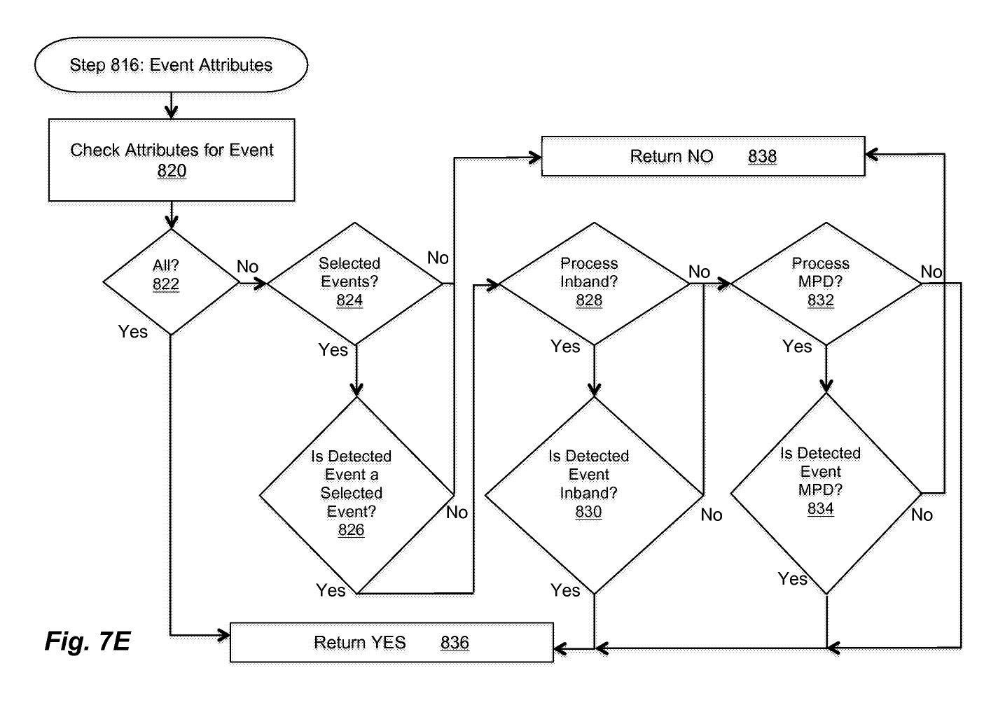

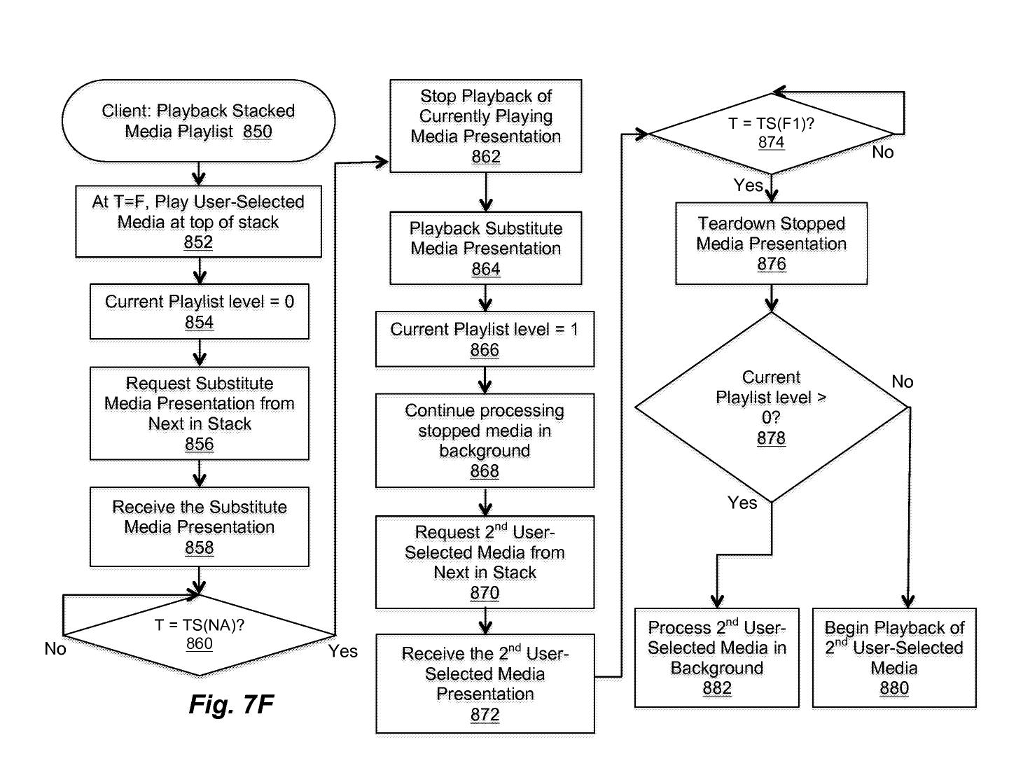

As discussed above, the command processor 602a of the media access engine 602 in FIG. 6A receives media playlists and processes the media playlists to provide server control over media playback. FIG. 7A is a flowchart 700 illustrating an example of the processing of a media playlist.

In its simplest form, the media playlist may comprise a single media source indicator formatted for transmission to the media player device 600. The single media source indicator may then be a deemed a command for the media player device 600 to playback the media presentation indicated by the media source indicator. The command processor 602a may receive a media playlist at step 702. At step 704, the command processor 602a identifies the media source indicator in the media playlist. The command processor 602a may request in step 706 that the media access engine 602 transmit a request for the media presentation indicated by the media source indicator. Alternatively, in step 706 the media access engine 602 may transmit the request for media at the instruction of the command processor 602a. In an example embodiment, such as for example a DASH implementation such as one illustrated in FIG. 6B, an HTTP Get command having the media source indicator (in the form of an URL, for example) is used in step 706 to request the media.

At step 708, a substitute media presentation is received at the media access engine 602, or instance of the media access engine 602. The substitute media presentation may include a start time indicator. If so, the current time is compared to the start time indicator of the substitute media indicator at step 710. If the current time is the time indicated for playback of the substitute media presentation, the currently playing media presentation is stopped at step 712. The substitute media presentation is then played at step 714.

At decision block 714, the playback of the substitute media presentation is checked to determine if it is complete. If it is complete, the stopped media presentation is resumed at step 718.

FIG. 7B is a flowchart illustrating operation when a second substitute media source indicator is received at the command processor as shown at step 752. In an example occurrence in an example implementation, the first substitute media presentation may be a national ad and the second substitute media presentation may be a local ad. Either the first or second substitute media presentations may also be an emergency alert, media blackout, a public service announcement, or the like. A request for the second substitute media presentation, for example, in the form of an HTTP Get message is directed to the network location indicated by the media source indicator at step 756. The second substitute media presentation is received by the media access engine at step 758. The time is monitored by the command processor as illustrated by decision block 760 and when time reaches the time indicated by the second substitute media playback time, the currently playing media is stopped at step 762. Playback of the second substitute media presentation is started at step 764. Playback of the second substitute media presentation is checked in decision block 766. When playback is complete, decision block 768 checks if the stopped media presentation is the first substitute media presentation. The first substitute media presentation is resumed at step 774 if it is the media presentation stopped for playback the second substitute media presentation. Decision block 772 checks if the stopped media presentation is the main media presentation. The user selected media presentation is resumed at step 776 if decision block 772 determines that the user selected media presentation was stopped for playback of the second substitute media presentation. In some embodiments, the timeline of either the first substitute media presentation or of the user selected media presentation may be checked to determine if either should still be playing at the time of the completion of the playback of the second substitute media presentation.

FIG. 7C is a flowchart illustrating operation of a paused media presentation in stop mode and in background mode. The process illustrated by the flowchart in FIG. 7C may be performed in step 712 of FIG. 7A when the currently playing media presentation is stopped or preempted by a newly arrived substitute media presentation. When playback of the currently playing media presentation is stopped, the characteristics of the stopped media presentation are checked to determine if a particular paused behavior is indicated. For example, when the server transmits a feed containing a media playback request to play the stopped media presentation, a parameter may indicate whether the paused behavior is to be in stop mode or in background mode as shown in Table 4 above. In another embodiment, some other indication may be checked to determine if, for example, the stopped media presentation is a VOD media presentation or a live performance media presentation. The VOD media presentation would likely have a stop mode as a paused behavior and the live performance media presentation would likely have a background mode. The check for any indicated paused behavior with respect to the stopped media presentation is performed at step 780. The indication of the paused behavior is checked to determine if it is stop mode or background mode at decision block 782. If background mode, the audio and video output of media from the media presentation is stopped so that it is no longer displayed or made audible at step 786. At step 790, processing of the timeline of the media presentation is continued such that playback is resumed in real time at the point where the media presentation would be playing if it had not been preempted. If stop mode at decision block 782, processing of the media presentation is stopped and the timeline is not monitored so that playback resumes at the point where the media presentation was stopped.

FIG. 7D is a flowchart illustrating operation of the media player device of FIG. 7A in which an event parameter is in a media playback request. The process illustrated by the flowchart in FIG. 7D may be performed in step 712 of FIG. 7A when the currently playing media presentation is stopped or preempted by a newly arrived substitute media presentation. The flowchart in FIG. 7D illustrates processing of an event parameter that may be specified in a feed, such as for example, the first XML element 400 with the event parameter 410 in FIG. 4. At step 802 in FIG. 7D, the characteristics of the preempted main media presentation are checked for parameters. At decision block 804, the parameters are checked for the event parameter.

If decision block 804 determines that an event parameter or element is not specified in a given feed, the currently playing media presentation is stopped at step 806 and processing of the timeline of the currently playing media presentation is continued at step 808 without monitoring for events.

As described above with reference to FIG. 4, event parameters may be specified in a feed in order to ensure that selected events that may be embedded in the subject media presentation media stream are not missed when preempted by a substitute media presentation. In a DASH implementation, events according to DASH may be used to notify the media player device 650 (in FIG. 6B) that processes the commands, or an application 656 (in FIG. 6B) controlling the media access engine 652 (in FIG. 6B), or a module contained in the application 656 (in FIG. 6B). The above description of media playlists, or MPD URL lists in a DASH implementation, for interrupting playback of MPD media on a media player device implement an approach in which a server knows when to interrupt playback of an MPD and when to schedule playback of different content. This approach is complicated in a DASH implementation of the use case involving app-driven ad insertion as described above.

In example embodiments, the media playlist approach may be augmented with an event-based mechanism in the form of an event parameter or element that may be specified in a feed for playback of the media presentation having events. In a DASH implementation, a DASH event arriving inband or in the MPD can provide media-related information that the application logic can use in order to perform actions possibly resulting in pausing/stopping the playback of the DASH content from which this event originated.

If an event parameter is specified as determined at decision block 804 in FIG. 7D, the audio and video output of the media stream from the stopped media presentation is stopped at step 810. Processing of the stopped media presentation is continued in order to monitor the timeline of the stopped media presentation at step 812. It is noted that in an example implementation for steps 810 and 812, the media presentation that is stopped may be implemented by an instance of the media access engine of the media player device. A new instance may be generated for processing of the substitute media presentation at step 714 in FIG. 7A. Steps 810 and 812 in FIG. 7D may involve setting the player state of the instance of the stopped or preempted media presentation to an inactive state that is not displayed, but continues processing in the background. The instance of the media access engine that plays the substitute media presentation would be set to the active state.

The timeline of the stopped media presentation may be monitored by analyzing the media stream or media presentation for events. In an example DASH implementation, when a command or a media playback request or a feed indicates that the DASH client is to monitor a presentation for events (e.g., such monitoring possibly being required during a period in which that DASH client is in a paused state as in the example illustrated in FIG. 7D), the DASH client will analyze all or a specified subset of events and will maintain the updated MPD (including, for example, listening to MPD Validity Expiration, MPD Patch or MPD Update event), resolve XLink if needed, etc. The DASH client will download only segments from an event-bearing representation and will further only extract the events and process them.

Referring to FIG. 7D, if decision block 814 indicates that an event is detected, decision block 816 determines if this event is an event that the event parameter and any attributes identifies as an event that is to be processed even if the media presentation containing the event is in a stopped state. Decision block 816 may involve checking the characteristics of the stopped media presentation to determine if its feed or media playback request contained any attributes limiting which events are to be processed. FIG. 7E illustrates operation of a process for checking event attributes to determine if a specific event is to be processed when detected during background processing of a media presentation. If decision block 816 indicates an event is to be processed, the event is processed at step 818.

An example DASH implementation that uses SCTE 35 cue messages monitors for events in either active or passive state of a given MPD (as described above) and passes the event to the application 656 (in FIG. 6B). The application 656 may perform an operation such as a local computation or request from a server triggered by this event and possibly using parameters contained in the event. In an example of such behavior, the application 656 sends a request to an ad decision server. The request would contain the parameters from the SCTE 35 message and client-identifying information (e.g., Facebook or Google+identity, phone number, GPS location, or any opaque provider-assigned identifier). The ad decision server would then make an ad decision given these parameters. A new command or attribute of another command, or a parameter of another command, may be defined for execution by the media access engine 652 (in FIG. 6B) that processes the commands (e.g., pausing the current MPD or/and playlist/stack, and starting a new MPD/playlist/stack containing an ad).

Another example DASH implementation may use an SCTE 130-10 XML document, which will be used by the application 656 (in FIG. 6B) to limit operation that it allows the user to perform. The SCTE 130-10 spec defines playback speed ranges, such as 1.0 (normal playback), 0.0 (pause), >1.0 (fast forward), <0.0 (rewind) that may be used in a specific time range within the content.

FIG. 7E is a flowchart illustrating operation of a server-controlled session involving an event parameter with event attributes indicating which events are to be monitored. The process illustrated in the flowchart in FIG. 7E may be performed for example at decision block 816 in FIG. 7D in determining which events encountered in an active or passive media presentation are to be processed. A media playback request or feed specifying playback of a media presentation may include an event parameter as shown in the event parameter 410 in the schedule command element 400 in FIG. 4. Examples of attributes that may be used to define behavior when detecting an event are listed in Table 4.

When an event is detected in an active or passive media presentation, the characteristics of the media presentation may be checked for attributes specified in the media playback request that signaled the media presentation. In the flowchart in FIG. 7E, attributes or parameters of the media presentation for which events are monitored while in a passive state are checked at step 820.

At decision block 822, the media presentation attributes are checked for the ALL attribute for the Event parameter. If the ALL attribute is indicated for the media presentation, a YES is returned at step 836 for decision block 816 in FIG. 7D. A YES returned to decision block 816 in FIG. 7D confirms that the attributes specified for the event parameter in the media playback request that signaled the media presentation in the passive state indicate that the detected event is to be processed.

At decision block 824, the attributes are checked for specification of selected events that are to be monitored. The attributes may indicate selected events using, for example, a list numerically identifying specific events, or an eventURN list specifying URNs of selected events, as listed in Table 4 above. If decision block 824 determines that selected events are to be monitored, the event detected at decision block 814 in FIG. 7D is checked to determine if this event is one of the events selected by attributes. If the event is not one of the events selected for processing or monitoring, a NO is returned at step 838 to decision block 816 in FIG. 7D. A NO returned to decision block 816 in FIG. 7D confirms that the attributes specified for the event parameter in the media playback request that signaled the media presentation in the passive state indicate that the detected event is not to be processed.

If the event is one of the events selected for processing, an attribute such as the @eventSource attribute described above in Table 4, may indicate that the detected event is to be processed only if it is an inband event or an MPD event. The @eventSource attribute may be indicated as an attribute of events specified in the event parameter.

Decision block 828 determines if the selection is limited to processing events that are in-band. If only the selected events detected inband are to be processed, decision block 830 determines if the detected event is an inband event. If it is, a YES is returned to decision block 814 in FIG. 7D at step 836. If decision block determines that the selected event is not inband, decision block 832 determines if the selection of the event is limited to MPD events. If only MPD events are to be monitored or processed, decision block 834 determines if the detected event is an MPD event. If it is, a YES is returned to decision block 814 in FIG. 7D at step 836. If the selected event is not limited to either inband or MPD events, a YES is returned to decision block 814.

It is noted that the description of the flowchart in FIG. 7E assumes a DASH implementation is used. Implementations using other protocols that specify a construct analogous to the DASH Event construct may implement a similar process for determining if a detected event is to be processed.

The description above of servers that generate media playlists to transmit to media player devices for server-controlled media streaming indicated transmitting media playlists as tiered media playlists and stacked playlists. The media playback device 600 in FIG. 6A (or 650 in FIG. 6B) may be configured to process tiered media playlists by processing media playback requests received individually as described with reference to the flowcharts in FIG. 7A. FIG. 7F is a flowchart illustrating operation of server-controlled session in a media playback device configured to process stacked media playlists.

The media player device 600 in FIG. 6A (or 650 in FIG. 6B) receives the stacked playlist configured as described above with reference to FIG. 5 and Table 3. The first media playback request in the stack indicates a main media presentation to be played at time, T=TS(F), with a playlist level parameter=0. The first substitute media presentation is indicated to play at time, T=TS(NA), with a playlist level parameter=1. The second main media presentation is indicated to play at time, T=TS(F1), with a playlist level parameter=0. The second substitute media presentation is indicated to play at time, T=TS(L), with a playlist level parameter=2.

Referring to FIG. 7F, at time T=F step 852, the media player device 600 begins playback of the main media presentation indicated in the media presentation at the top of the stack. The current playlist level is set to 0 in step 854, which is the playlist level parameter for the main media presentation.

The media access engine 602 in FIG. 6A sends a request for the substitute media presentation indicated in the next media playback request in the stack at step 856. The substitute media presentation is received at step 858 and playback of the substitute media presentation is not started until time T=TS(NA). When time T=TS(NA) is indicated at decision block 860, playback of the currently playing main media presentation is stopped at step 862. In an example implementation, playback of the main media presentation is stopped by disabling communication of a media stream from the instance of media access engine playing the main media presentation while continuing the processing of the instance. The main media presentation may be described as being in a passive or inactive state even though it's processing, or monitoring of its timeline continues.

Playback of the substitute media presentation is started at step 864. In an example implementation, playback of the substitute media presentation starts with the creation of a new instance of the media access engine to play the substitute media presentation. The transmission of media stream from the new instance to the media playback engine is enabled and the substitute media presentation is described as being in an active state. The current playlist level is set to 1 at step 866, which is the playlist level parameter for the substitute media presentation. In the meantime, processing continues for the main media presentation in its passive state at step 868.

The media access engine 602 in FIG. 6A sends a request for the second substitute media presentation indicated in the next media playback request in the stack at step 870. The second main media presentation is received by the media player device 600 at step 872. When time T=TS(F1) is indicated at decision block 874, the main media presentation that was preempted by the substitute media presentation is torn down at step 876. In an example implementation, the main media presentation may be torn down by deleting or otherwise disabling the instance of the media access engine used to process the main media presentation.

At decision block 878, the current playlist level is checked. If the current playlist level is greater than 0, the second main playlist is processed in a passive state without display or audio output of its media. If the current playlist level is 0, playback of the second main media presentation is started at step 880.

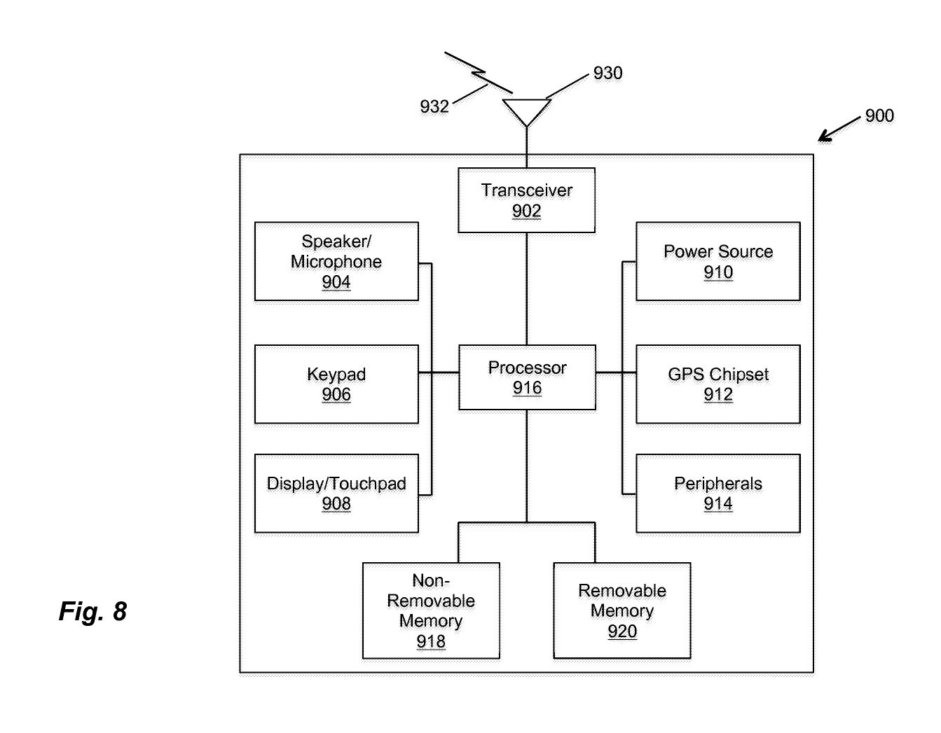

FIG. 8 is a system diagram of an example WTRU, which may be used as the media player device 600 in FIG. 6A (or 650 in FIG. 6B). As shown, the example WTRU 900 may include a processor 916, a transceiver 902, a transmit/receive element 930, a speaker/microphone 904, a keypad or keyboard 906, a display/touchpad 908, non-removable memory 918, removable memory 920, a power source 910, a global positioning system (GPS) chipset 912, and/or other peripherals 914. It will be appreciated that the WTRU 900 may include any sub-combination of the foregoing elements while remaining consistent with an embodiment.

The processor 916 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 916 may perform signal coding, data processing, power control, input/output processing, and/or any other functionality that enables the WTRU 900 to operate in a wired and/or wireless environment. The processor 916 may be coupled to the transceiver 902, which may be coupled to the transmit/receive element 930. While FIG. 8 depicts the processor 916 and the transceiver 902 as separate components, it will be appreciated that the processor 916 and the transceiver 902 may be integrated together in an electronic package and/or chip.

The transmit/receive element 930 may be configured to transmit signals to, and/or receive signals from, another terminal over an air interface 932. For example, in one or more embodiments, the transmit/receive element 930 may be an antenna configured to transmit and/or receive RF signals. In one or more embodiments, the transmit/receive element 930 may be an emitter/detector configured to transmit and/or receive IR, UV, or visible light signals, for example. In one or more embodiments, the transmit/receive element 930 may be configured to transmit and/or receive both RF and light signals. It will be appreciated that the transmit/receive element 930 may be configured to transmit and/or receive any combination of wireless signals.

The transceiver 902 may be configured to modulate the signals that are to be transmitted by the transmit/receive element 930 and/or to demodulate the signals that are received by the transmit/receive element 930. As noted above, the WTRU 900 may have multi-mode capabilities. Thus, the transceiver 902 may include multiple transceivers for enabling the WTRU 900 to communicate via multiple RATs, such as UTRA and IEEE 802.11, for example.

The processor 916 of the WTRU 900 may be coupled to, and may receive user input data from, the speaker/microphone 904, the keypad 906, and/or the display/touchpad 908 (e.g., a liquid crystal display (LCD) display unit or organic light-emitting diode (OLED) display unit). The processor 916 may also output user data to the speaker/microphone 904, the keypad 906, and/or the display/touchpad 908. In addition, the processor 916 may access information from, and store data in, any type of suitable memory, such as the non-removable memory 918 and/or the removable memory 920. The non-removable memory 918 may include random-access memory (RAM), read-only memory (ROM), a hard disk, or any other type of memory storage device. The removable memory 920 may include a subscriber identity module (SIM) card, a memory stick, a secure digital (SD) memory card, and the like. In one or more embodiments, the processor 916 may access information from, and store data in, memory that is not physically located on the WTRU 900, such as on a server or a home computer (not shown).

The processor 916 may be coupled to the GPS chipset 912, which may be configured to provide location information (e.g., longitude and latitude) regarding the current location of the WTRU 900. In addition to, or in lieu of, the information from the GPS chipset 912, the WTRU 900 may receive location information over the air interface 932 from a terminal (e.g., a base station) and/or determine its location based on the timing of the signals being received from two or more nearby base stations. It will be appreciated that the WTRU 900 may acquire location information by way of any suitable location-determination method while remaining consistent with an embodiment.

The processor 916 may further be coupled to other peripherals 914, which may include one or more software and/or hardware modules that provide additional features, functionality and/or wired or wireless connectivity. For example, the peripherals 914 may include an accelerometer, orientation sensors, motion sensors, a proximity sensor, an e-compass, a satellite transceiver, a digital camera and/or video recorder (e.g., for photographs and/or video), a universal serial bus (USB) port, a vibration device, a television transceiver, a hands free headset, a Bluetooth® module, a frequency modulated (FM) radio unit, and software modules such as a digital music player, a media player, a video game player module, an Internet browser, and the like.

By way of example, the WTRU 900 may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a tablet computer, a personal computer, a wireless sensor, consumer electronics, or any other terminal capable of receiving and processing compressed video communications.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method comprising:
generating a media playlist comprising at least one substitute media source indicator indicating a network location of a corresponding substitute Media Presentation Description (MPD); and
sending the media playlist to a media player device to instruct the media player device to interrupt playback of a currently playing MPD and to playback the substitute MPD.

2. The method of claim 1 where each substitute media source indicator is sent with a substitute media start time indicating a start time for playback of the substitute MPD at the substitute media source indicator, and where the step of generating the media playlist comprises forming a tiered media list for playback of a main MPD, the tiered media list comprising:
a main media source indicator indicating a network location of media for a main MPD and a main media start time as a first tier of the tiered media list,
the substitute media source indicator and substitute media start time as a second tier of the media playlist, the substitute media start time selected such that the media player device interrupts playback of the main MPD for playback of the substitute MPD, and
a next-tier substitute media source indicator and next-tier media start time as a next-tier of the media playlist; and where the step of sending the tiered media list comprises sequentially sending each tier separately for the playback device to process each tier as an individual presentation.

3. The method of claim 1 where the step of generating the media playlist comprises forming a stacked playlist comprising:
at least one main media source indicator corresponding to a main MPD and a corresponding main media playback time;
the at least one substitute media source indicator corresponding to the substitute MPD and a corresponding substitute media playback time;
where the step of sending the media playlist further comprises sending the stacked playlist to the media player device to process the stacked playlist as a list of MPDs.

4. The method of claim 3 where the stacked playlist further comprises:
a playlist level parameter for each of the at least one main media source indicator, and the at least one substitute media source indicator, where the playlist level parameter indicates a level distinguishing the MPDs indicated by the at least one main media source indicator from the MPDs indicated by the at least one substitute media source indicator.

5. A method for server-controlled playback of media on a media player device comprising:
receiving a substitute media source indicator indicating a network location of a substitute MPD;
sending a request for the substitute MPD to the network location indicated by the substitute media source indicator;
receiving the substitute MPD;
interrupting playback of a currently playing MPD; and
playing the substitute MPD.

6. The method of claim 5 where the substitute media presentation MPD is a first substitute MPD, the method further comprising:
receiving a second substitute media source indicator during the playing of the substitute MPD, the second substitute media source indicator indicating a network location of a second substitute MPD;
sending a request for the second substitute MPD to the network location indicated by the second substitute media source indicator;
receiving the second substitute MPD;
stopping playback of a currently playing substitute MPD; and
playing the second substitute MPD.

7. The method of claim 5 further comprising:
receiving a first media playback request comprising a main media source indicator indicating a network location of a main MPD and a main media playback time;
sending a request for the main MPD to the network location indicated by the main media source indicator;
receiving the main MPD; and
playing the main MPD at the main media playback time;
where the step of receiving the substitute media source indicator includes receiving the substitute media source indicator in a second media playback request comprising the substitute media source indicator and a substitute media playback time to perform the step of interrupting playback of the currently playing MPD and the step of playing the substitute MPD.

8. The method of claim 7 where the step of interrupting playback of the currently playing MPD when the currently playing MPD is the main MPD comprises processing the currently playing MPD without displaying video from the main MPD, and where the first media playback request includes an event parameter instructing the media player device to process events detected during processing of the main MPD, the method further comprising:
detecting the event parameter in the first media playback request;
stopping the playback of the substitute MPD when an event is detected in the main media presentation during processing of the main MPD; and
processing the event detected.

9. The method of claim 8 where the first media playback request includes an event attribute corresponding to the event parameter, where the event attribute identifies at least one event to be processed, the method further comprising:
performing the step of stopping the playback of the substitute MPD when an event corresponding to the event attribute is detected in the main MPD during processing of the main media presentation MPD; and
processing the event corresponding to the at least one event indicated by the event attribute.

10. The method of claim 8 where the first media playback request includes an event attribute corresponding to the event parameter, where the event attribute indicates all events in the MPD are to be processed, the method further comprising:
performing the step of stopping the playback of the substitute MPD when any event is detected in the main MPD; and
processing each event.

11. The method of claim 8 where the first media playback request includes an event attribute corresponding to the event parameter, where the event attribute indicates a list of selected events in the main MPD is to be processed, the method further comprising:
performing the step of stopping the playback of the substitute MPD when any one of the list of selected events is detected in the main media presentation; and
processing each one of the list of selected events.

12. The method of claim 8 where the first media playback request includes an event attribute corresponding to the event parameter, where the event attribute indicates an event media location indicator indicating a network location for the event, the method further comprising:
performing the step of stopping the playback of the substitute MPD when the event is detected in the main media presentation; where the step of processing the event comprises accessing the event using the event media location indicator in the event attribute.

13. The method of claim 7 where:
the first media playback request includes a first playlist level parameter indicating the first media source indicator is associated with a main MPD type;
the substitute media playback request includes a second playlist level parameter indicating the substitute media source indicator is associated with a substitute MPD type; the method further comprising:
maintaining a current playlist level indicator set to the first playlist level when the main MPD is playing, and to the second playlist level when the substitute MPD has interrupted the main MPD;
where the step of interrupting the currently playing MPD comprises:
setting the current playlist level indicator to the second playlist level;
continuing processing of the main MPD while in an interrupted state after being interrupted by the first substitute MPD without displaying video in the main MPD.

14. The method of claim 13 where:
the main MPD is a first main MPD;
the main media source indicator is a first main media source indicator;
the substitute media source indicator is a first substitute media source indicator;
the substitute MPD is a first substitute MPD;
the first and second media playback requests are received in a stacked media list further comprising:
a third media playback request comprising a second main media source indicator indicating a network location of a second main MPD, a second main media playback time, and the first playlist level indicator; and
a fourth media playback request comprising a second substitute media source indicator indicating a network location for a second substitute MPD, a second substitute media playback time, and the second playlist level parameter;
where the method further comprises:
monitoring a playback time;
when a current playback time is the second main media playback time, tearing down playback of the first-user selected MPD;
setting up playback of the second main MPD while withholding video display of the second main MPD until the current playlist level indicator is set to the first playlist level.

15. A media player device comprising:
a data network interface configured to send and receive data over a data network;
a media access engine configured to communicate requests for MPDs and to receive media playback requests over the data network via the data network interface
a media playback engine configured to receive a video stream associated with a currently playing MPD and to communicate the video to a display device;
a command processor, and a non-transitory computer-readable medium storing executable instructions that, when executed by the command processor, are operative to:
receive a substitute media source indicator indicating a network location of a substitute MPD;
send a request for the substitute MPD to the network location indicated by the substitute media source indicator;
receive the substitute MPD;
interrupt playback of a currently playing MPD; and
play the substitute MPD.

16. The system of claim 15 where the substitute MPD is a first substitute MPD, and where the non-transitory computer readable medium stores executable instructions that when executed by the command processor, are operative to:
receive a second substitute media source indicator during the playing of the substitute MPD, the second substitute media source indicator indicating a network location of a second substitute MPD;
send a request for the second substitute MPD to the network location indicated by the second substitute media source indicator;
receive the second substitute MPD;
stop playback of a currently playing substitute MPD; and
play the second substitute MPD.

17. The system of claim 15 where the non-transitory computer readable medium stores executable instructions that when executed by the command processor, are operative to:
receive a first media playback request comprising a main media source indicator indicating a network location of a main MPD and a main media playback time;
send a request for the main MPD to the network location indicated by the main media source indicator;
receive the main MPD; and
play the main MPD at the main media playback time;
where the step of receiving the substitute media source indicator includes receiving the substitute media source indicator in a second media playback request comprising the substitute media source indicator and a substitute media playback time to perform the step of interrupting playback of the currently playing presentation and the step of playing the substitute MPD.

18. The system of claim 17 where the first media playback request includes a paused behavior parameter indicating whether the main MPD is interrupted in a stop mode or in a background mode, where the non-transitory computer readable medium stores executable instructions that when executed by the command processor, are operative to:
in a stop mode, stop playback of the main MPD such that playback resumes at a point at which the main MPD was stopped; and
in a background mode, stop playback and process the main MPD without displaying media such that playback resumes at a point at which the main MPD would be if the main MPD was not stopped.

19. The system of claim 17 where the first media playback request includes a command parameter, and where the non-transitory computer readable medium stores executable instructions that when executed by the command processor, are operative to:
when the command parameter is a schedule command, schedule playback of the main MPD associated with the main media source indicator at an indicated time;
when the command parameter is a teardown command, stop the currently playing MPD without resuming playback; and
when the command parameter is a replace command, replace the currently playing MPD with a replacement MPD indicated in the first media playback request.

20. The system of claim 17 where the step of interrupting playback of the currently playing MPD when the currently playing MPD is the main MPD comprises processing the currently playing MPD without displaying video from the main MPD, and where the first media playback request includes an event parameter indicating the presence of an event in the main MPD, and where the non-transitory computer readable medium stores executable instructions that when executed by the command processor, are operative to:
detect the event parameter in the first media playback request;
stop the playback of the substitute MPD when an event is detected in the main MPD during processing of the main MPD; and
process the event detected.
